(19) United States
(12) Patent Application Publication
(10) Pub. No.: US 2016/0301239 A1
(43) Pub. Date: Oct. 13, 2016

(54) Charging Coil Holding Device for an Implantable Medical Device Coupleable to a Controller/Charger Device

(71) Applicant: Boston Scientific Neuromodulation Corporation, Valencia, CA (US)

(72) Inventor: Jeffery Van Funderburk, Stevenson Ranch, CA (US)

(21) Appl. No.: 15/015,862

(22) Filed: Feb. 4, 2016

Related U.S. Application Data
(60) Provisional application No. 62/144,758, filed on Apr. 8, 2015.

(51) Int. Cl. H02J 7/02; H02J 7/00

(52) U.S. Cl. CPC H02J 7/025; H02J 7/0036; H02J 2007/0096

(57) ABSTRACT

A holding device having an integrated charging coil assembly for an Implantable Medical Device (IMD) is disclosed which includes a pouch for carrying a controller/charger external device for the IMD. The charging coil assembly includes a charging coil and optionally a battery for providing power for driving the charging coil to produce a magnetic charging field for the IMD. The charging coil assembly is connected to a cable also integrated with the holding device, which cable terminates at a connector. The connector is proximate to a port on the controller/charger when inserted into the pouch, and thus can be connected thereto. When so connected, the controller/charger will automatically control the charging coil assembly to produce the magnetic charging field without further input by the patient or the need to access the Graphical User Interface (GUI) of the controller/charger.

### CROSS REFERENCE TO RELATED APPLICATIONS

This is a non-provisional of U.S. Provision Patent Application Ser. No. 62/144,758, filed Apr. 8, 2015, which is incorporated by reference in its entirety, and to which priority is claimed.

### FIELD OF THE INVENTION

The present invention relates to a data telemetry and power transfer system having particular applicability to implantable medical device systems.

### BACKGROUND

Implantable stimulation devices deliver electrical stimuli to nerves and tissues for the therapy of various biological disorders, such as pacemakers to treat cardiac arrhythmia, defibrillators to treat cardiac fibrillation, cochlear stimulators to treat deafness, retinal stimulators to treat blindness, muscle stimulators to produce coordinated limb movement, spinal cord stimulators to treat chronic pain, cortical and deep brain stimulators (DBS) to treat motor and psychological disorders, and other neural stimulators to treat urinary incontinence, sleep apnea, shoulder subluxation, etc. The description that follows will generally focus on the use of the invention within a spinal cord stimulation (SCS) system, such as that disclosed in U.S. Pat. No. 6,516,227. However, the present invention may find applicability with any implantable medical device (IMD) or in any IMD system.

As shown in FIG. 1, a SCS system includes an Implantable Pulse Generator (IPG) 10 (hereinafter, and more generically, IMD 10), which includes a biocompatible device case 12 formed of titanium for example. The case 12 typically holds the circuitry and battery 14 (FIG. 3) necessary for the IMD 10 to function. The IMD 10 is coupled to electrodes 16 via one or more electrode leads 18 (two of which are shown). The proximal ends of the leads 18 are coupled to the IMD 10 at one or more lead connectors 20 fixed in a header 22, which can comprise an epoxy for example. There are sixteen electrodes (E1-E16) in the illustrated example, although the number of leads and electrodes is application specific and therefore can vary. In an SCS application, two electrode leads 18 are typically implanted on the right and left side of the dura within the patient's spinal column. The proximal ends of the leads 18 are then tunneled through the patient's tissue 35 (FIG. 3) to a distant location, such as the buttocks, where the IMD case 12 is implanted, at which point they are coupled to the lead connectors 20.

An IMD 10 is typically supported by and communicates with one or more external devices, and FIGS. 2A and 2B provide examples of such devices. FIG. 2A depicts an external controller 40 for the IMD 10. The external controller 40 is used to establish a bi-directional wireless data link 45 with the IMD 10, as explained further with respect to FIG. 3. The external controller 40 is typically used to send or adjust the therapy settings the IMD 10 will provide to the patient. If the IMD 10 is an IPG 10 as depicted in FIG. 1, such therapy settings may include which electrodes 16 are active to issue therapeutic current pulses; whether such electrodes sink or source current (i.e., electrode polarity); the duration, frequency, and amplitude of the pulses, etc., which settings together comprise a stimulation program for the IMD 10. External controller 40 can also act as a receiver of data from the IMD 10, such as various data reporting on the IMD's status and the level of the IMD's battery 14.

As shown in FIG. 2A, external controller 40 is typically configured in a hand-held, portable housing 42, and powered by an internal battery (52; FIG. 3), which battery may be a primary battery or rechargeable. The external controller 40 includes a Graphical User Interface (GUI) similar to that used for a cell phone, including buttons 44 and a screen 46, and may have other interface aspects as well, such as a speaker. Circuitry within the housing is integrated via a printed circuit board (PCB) 54, which circuitry can include control circuitry such as a microcontroller 56.

While an external controller 40 is typically a device custom built by the manufacturer of the IMD 10 and dedicated in its functionality to IMD communications, external controller 40 may also comprise general purpose, freely programmable mobile device having suitable wireless communication functionality, such as a smart cell phone. In this case, a Medical Device Application (MDA) can be executed on the mobile device to configure the device's GUI for use as an IMD external controller, and to allow for control and monitoring of the IMD 10. See, e.g., U.S. Patent Application Publication 2015/0073498, which is incorporated herein by reference in its entirety.

FIG. 2B depicts an external charger 60 for the IMD 10, which is used to recharge the IMD 10′s rechargeable battery 14 by producing an AC magnetic charging field 65 (FIG. 3). The user interface of the external charger may be simple compared to the external controller 40. For example, the external charger 60 may lack a screen. Instead, the external charger 60 may simply include an on/off button 64 for magnetic charging field 65 generation, and a light emitting diode (LED) 66 to indicate when the magnetic field is being generated. Although not shown, external charger 60 may also include a speaker useful to indicate alignment between the external charger and the IMD 10, as is well known. See, e.g., U.S. Patent Application Publication 2013/0096651. External charger 60 is also typically hand-held and portable, and integrated within a housing 62.

Internal structures of the external controller 40, the external charger 60, and the IMD 10 are shown in cross section in FIG. 3, which also depicts the bi-directional data link 45 between the external controller 40 and the IMD 10, and the magnetic charging field 65 produced by the external charger 60 and used to charge the IMD's batter 14. Transmission of data on link 45 or power on link 65 occurs transcutaneously, i.e., through the patient's tissue 35.

IMD 10 as shown in FIG. 3 includes the battery 14 mentioned earlier, which is rechargeable in this example. Recharging of the battery 14 is assisted by a charging coil 24. The magnetic charging field 65 from the external charger 60 induces a current in this charging coil 24, which current is then rectified to DC levels and used to charge the battery 14. IMD 10 further includes circuitry 26, which may include general control circuitry such as a microcontroller, and stimulation circuitry for forming the therapeutic current pulses defined by the stimulation program at the electrodes 16. Circuitry in the IMD 10 is integrated via a PCB 30.

The magnetic charging field 65 is produced by a charging coil 66 in the external charger 60, with power for production of this field being provided by a primary or rechargeable battery 68. The coil 66 is typically electrically coupled to one or more circuit boards 70, 72 in the external charger 60, as is other circuitry 74 (control circuitry such as a microcontroller; coil driver circuitry, etc.). In the configuration shown in FIG. 3, circuitry 74 is affixed to a vertical circuit board 72 to reduce the generation in the circuitry 74 of Eddy currents caused by the magnetic charging field 65. Such Eddy currents may generate heat unwanted heat, providing a patient safety risk, and will also generally detract from the efficiency of power transfer by sinking some of the energy in the magnetic charging field 65. The battery 68 is also moved outside of the charging coil 66 for the same reason, as its typically-metallic case can also heat and sink magnetic charging field 65 energy. Magnetic charging field 65 may comprises a field of 80 kHz for example, and is usually not modulated with data when produced. However, Load Shift Keying (LSK) may be used to transmit data back to the external charger 60 during production of the magnetic charging field 65. LSK telemetry from the IMD 10 is discussed further below.

Because charging the battery 14 in the IMD 10 may take some time, it is desired to hold the external charger 60 in close proximity to and in alignment with the IMD 10 during a charging session when the magnetic charging field 65 is produced. Typically, and as disclosed in U.S. Publication 2014/0025140 and shown here in FIG. 4, this occurs using an external charger holding device 80, such as a belt 82. The belt 82 fastens around the patient's waist, and can be secured by a fastening device 84, such as a buckle, clasp, snaps, Velcro, etc. The belt 82 can be adjustable to fit patients with different waist sizes. The belt 82 includes a pouch 86, which is generally located on the belt 82 in a position where the IMD 10 is implanted in the patient, such as the back of the patient proximate to the buttocks in an SCS application. A slot 88 or other opening in the belt 82 allows the external charger 60 to be inserted into the pouch 86, such that the external changer 60 is, like the pouch 86, generally aligned with the IMD 10. Once placed in the pouch 86, the patient can press the on/off switch 64 (FIG. 3) on the external charger 60 to begin a charging session—i.e., to produce magnetic charging field 65—or the user can turn the charger on before inserting it in the pouch 86. Affixing the external charger 60 to the patient using belt 82 allows the patient to move or walk while using the external charger 60, and thus can charge his implant “on the go.” See also U.S. Publication 2012/0012630, describing another belt for an external charger.

Data communications between the IMD 10 and the external controller 40 (FIG. 2A) along link 45 is assisted by a telemetry antenna 28 in the IMD 10, as shown in FIG. 3. Telemetry antenna 28 can take different forms depending on the physics of the link 45. If magnetic induction is used with link 45 comprising an AC magnetic field, the antenna can comprise a coil antenna 28a. In this case, the antenna 50 provided in the external controller 40 may likewise comprise a coil antenna 50a. If short-range but far-field electromagnetic RF telemetry is used for link 45, the antenna in the IMD 10 can comprise an RF antenna 28b, such as a wire, slot, or patch antenna, as shown in dotted lines. In this case, the telemetry antenna 50 provided in the external controller 40 may likewise comprise an RF antenna 50b, as explained further in the above-incorporated '498 Publication.

Telemetry antenna 28 in the IMD 10 and telemetry antenna 50 in the external controller 40 preferably act to both transmit and receive data. As such, antennas 28 and 50 are respectively coupled to transceiver circuitry to modulate transmitted data and to demodulate received data according to a data scheme employed on link 45. For example, if coil antennas 28a and 50a are used, Frequency Shift Keying (FSK) can be used to modulate transmitted data on the link 45, as is well known. Although not shown, one or more orthogonal coil antennas 50a driven or received out of phase could be used in external controller 40 as well to improve communication coupling with the IMD 10 along link 45, as discussed in U.S. Publication 2009/0069869. If RF antennas 28b and 50b are respectively employed in the IMD 10 and external controller 40, short-range RF communication standards may be used on link 45, such as Bluetooth, WiFi, the Medical Implant Communication Service (MICS), or MedRadio, as explained further in the above-incorporated '498 Publication.

Although the external controller 40 and external charger 60 are depicted separately to this point, the art has recognized that the functionality of both of these devices can be integrated into a single device or system. One example disclosed in U.S. Pat. No. 8,335,569 depicts a combined controller/charger having a single housing, which housing includes the antennas (coils) necessary for both IMD data telemetry and IMD battery charging functions.

Another example of a controller/charger system 90 is disclosed in U.S. Pat. No. 8,498,716, and depicted here in FIGS. 5A and 5B. System 90 includes a controller/charger 100 that can be similar in construction and function to the external controller 40 (FIG. 2A). Thus, the controller/charger 100 again includes a hand-held, portable housing 42 and a GUI including buttons 44 and a screen 46. Housing 42 may also again contain one or more antennas 50a or 50b for communicating with the IMD 10 via a link 45 (FIG. 3), to transmit therapy settings or to receive IMD status information.

However, unlike the external controller 40 of FIG. 2A, the controller/charger 100 additionally contains circuitry to drive a charging coil assembly 110, which is attachable via a cable 112 and connector 114 to a port 48 (e.g., a USB port) on the housing 42. The charging coil assembly 110 includes a charging coil 116 similar in function to the coil 66 used in the external charger 60 (FIGS. 2B, 3). Charging coil 116 may be mounted to a substrate 118 in the assembly 110, which may comprise a circuit board, and may include contact points for ends of the charging coil 116 and for the termination 120 of the signals in cable 112. Substrate 118 may be flexible, such as made of polyimide or Kapton for example, or rigid like a traditional printed circuit board. The charging coil assembly 110 may include a housing 122 for the coil 116 and substrate 118, which may comprise an overmolded material such as silicone or hard plastic for example. As shown, a hole 124 may be present in the housing 122 of the assembly 110 in the center of the charging coil 116. Although not shown, the charging coil assembly 110 may additionally contain one or more temperature sensing devices, such as thermistors or thermocouples, to measure the temperature of the assembly 110 and to report such temperature to the external controller/charger 100 so that production of the magnetic charging field 65 can be controlled accordingly (e.g., so as to not exceed a safe temperature set point). The charging coil assembly 110 may also be used in conjunction with a holding device 80 (FIG. 4) and slipped into its pouch 86 to align the charging coil 116 with the IMD 10 during a charging session.

The external controller/charger 100 of the '716 patent is programmed to allow a user to charge the IMD battery 14 via the charging coil assembly 110 using the GUI of the device 100, with appropriate user selection at the GUI causing magnetic charging field 65 to be produced, as shown in FIG. 5B.

The implementation of the controller/charger system 90 is touted in the '716 patent as beneficial integrating both battery charging and data telemetry functionality for an IMD patient. However, the inventor considers that system 90 can be overcomplicated, particularly because of its requirement that the patient use the GUI of the controller/charger 100 to charge his IMD 10. Even if the charging coil assembly 110 is positioned in a pouch 86 of a belt 80, such as illustrated in FIG. 4, the patient must still carry and access the controller/charger 100 to which it is tethered to begin charging. As charging of the IMD's battery 14 may take several minutes, patient mobility is hampered by the need to carry the controller/charger 100. Additionally, to the extent the charging coil assembly 110 is used with a holding device 80, a user must carry all three of the holding device 80, the charging coil assembly 110, and the controller/charger 100 to cover the contingencies of controlling or monitoring the IMD 10 and charging of its battery 14. A simpler solution integrating both IMD data communications and charging is thus presented.

### BRIEF DESCRIPTION OF THE DRAWINGS

FIG. 1 shows an implantable pulse generator (IPG) type of implantable medical device (IMD), and the manner in which an electrode array is coupled to the IPG, in accordance with the prior art.

FIGS. 2A and 2B show external devices for an IMD, including an external controller (FIG. 2A) and an external charger (FIG. 2B), in accordance with the prior art.

FIG. 3 shows the IMD, the external controller, and the external charger in cross section, and shows wireless communication of data between the external controller and the IMD, and wireless transfer of power from the external charger to the IMD, in accordance with the prior art.

FIG. 4 shows use of a holding device such as a belt to hold an external charger in close proximity to and in alignment with the IMD during a charging session, in accordance with the prior art.

FIG. 5A shows a controller/charger system comprising a controller/charger device with a detachable charging coil assembly, and FIG. 5B shows the assembly in communication with the IMD, in accordance with the prior art.

FIG. 6 shows a holding device with an integrated charging coil assembly, and including a pouch for holding a controller/charger, in accordance with an example of the invention.

FIGS. 7A-7E show different variations of the circuitry in the controller/charger and in the charging coil assembly, in accordance with examples of the invention.

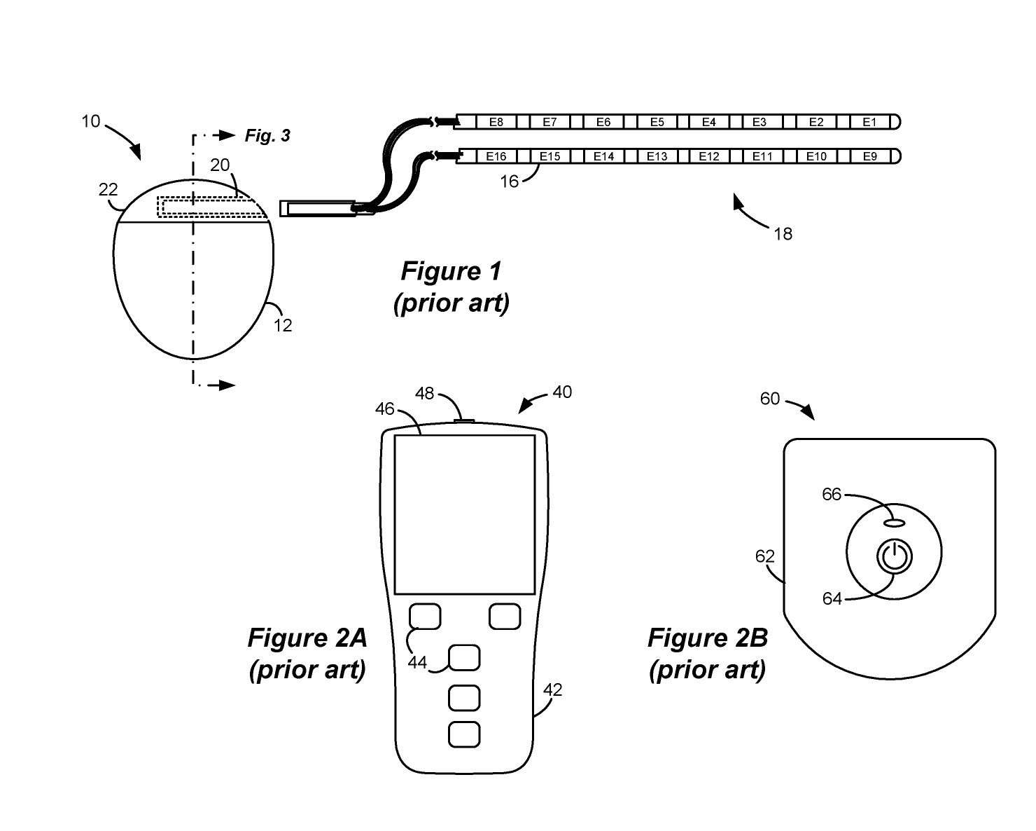

### DETAILED DESCRIPTION

A holding device such as a belt having an integrated charging coil assembly for an Implantable Medical Device (IMD) is disclosed which includes a pouch for carrying an controller/charger for the IMD. The charging coil assembly includes a charging coil and optionally a battery for providing power for driving the charging coil to produce a magnetic charging field for the IMD. The charging coil assembly is connected to a cable also integrated with the holding device, which cable terminates at a connector. The connector is proximate to a port on the controller/charger when inserted into the pouch, and thus can be connected thereto. When so connected, the controller/charger will automatically control the charging coil assembly to produce the magnetic charging field without further input by the patient or the need to access the Graphical User Interface (GUI) of the controller/charger. Once charging is complete, the controller/charger can notify the patient, who can then disconnect the controller/charger, and remove the controller/charger and the holding device. Because the holding device holds both the charging coil assembly and the controller/charger firmly, patient mobility is not hampered and the patient need not hold the controller/charger.

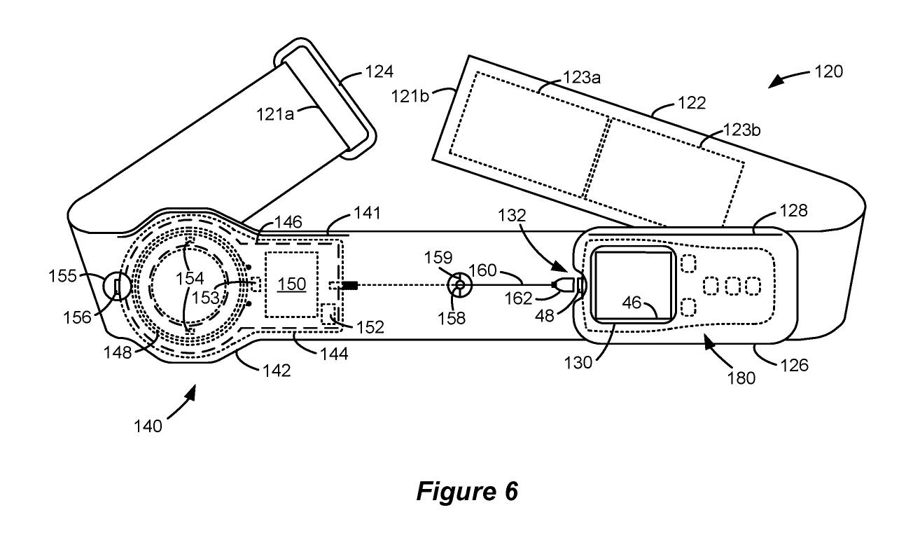

FIG. 6 shows an example of the disclosed holding device 120. In the example shown, the holding device comprises a belt 122 that may be worn by an IMD patient. The belt 122 may be formed of cloth such as nylon for example. As shown, belt 122 includes a loop 124 at first end 121a through which the second end 121b of the belt may be passed to fasten the belt 122 to the patient. The second end 121b may include opposing Velcro surfaces 123a and 123b to allow the second end to be secured after passage through the loop. Such fastening means are just one example, and many other well-known fastening means (e.g., buckles, clasps, snaps, hooks, etc.) could be used as well. The belt 122 is preferably formed of inner and outer pieces of cloth, thus allowing electronics to be held within the belt, as explained further below.

Additionally, the holding device 120 need not be fastenable at its ends 121a and 121b to form a closed loop. Instead, and as disclosed in the above-referenced '140 Publication, the ends 121a and 121b may remain unconnected while still wearable by the patient. This is particularly useful if the holding device 120 comprise a collar draped around a patient's neck, as is useful in a Deep Brain Stimulation (DBS) application for example. The holding device 120 may alternatively be wearable by being affixable to the patient or his clothing by an adhesive for example.

A charging coil assembly 140 is preferably integrated within the belt 122. Such integration of the charging coil assembly 140 may be effectively permanent, with the assembly 140 stitched between the inner and outer pieces of belt cloth. Alternatively, the belt 122 may be formed of a rubberized material and molded around the charging coil assembly 140. Integration may also be semi-permanent, in which the charging coil assembly 140 is insertable within the belt 122 and thereafter largely left there, although also removeable from time to time (such as to wash the belt, or to switch out the charging coil assmebly 140). In this regard, the belt 122 can include a slot 141 into which the charging coil assembly 140 can be inserted between the inner and outer pieces of belt cloth. Although not shown, slot 141 may be openable and closeable, and may include a Velcro flap in one example. The belt 122 may include a flared portion 142 if the charging coil assembly 140 is larger than the width of the belt. Integration (including permanent or semi-permanent as defined above) of the charging coil assembly 140 with the belt 122 renders one less article for the patient to carry.

In the example shown, the charging coil assembly includes a housing 144 which integrates its components, including a charging coil 148. The housing 144 may comprise a hard plastic for example, but could also comprise softer overmolded materials such as silicone depending on its construction and other components in the assembly 140, which components may vary as explained further below. In the example shown, the charging coil assembly 140 includes a battery 150 and additional circuitry 152, explained further below. The assembly 140 may further include a tuning capacitor 153 for establishing an L-C circuit with the inductance of the charging coil 148, and temperature measuring electronics such as thermistors 154 to monitor the temperature of the assembly 140 during production of the magnetic charging field 65. Such components may be integrated by a substrate (e.g., circuit board) 146 within the housing 144. It is not strictly necessary that all electronic components of the charging coil assembly 140 be contained within the housing 144. For example, the charging coil 148 may exist outside of or be affixed to the outside of the housing 144. Note that housing 144 is not strictly required in all examples of the charging coil assembly 140.

The belt 122 need not completely enclose the charging coil assembly 140, and instead an opening 155 may be provided to allow access to the assembly. For example, the assembly 140 can include a port 156 for allowing electronic access to the assembly 140, to charge its battery 150 for example (if present). Port 156 may comprise a Universal Serial Bus (USB) port for example.

A cable 160 is attached to the housing 144 of the charging coil assembly 140, which cable 160 may be at least partially integrated within the belt 122. For example, and as shown, the cable 160 can progress between the inner and outer pieces of the belt fabric for a distance, but then emanate through the outer portion via an opening 158. The cable 160 terminates at a connector 162. The opening 158 may contain slits 159 to allow the connector 162 to pass therethrough, as may be necessary if the charging coil assembly 140 is inserted into or removed from the belt 122 as discussed previously.

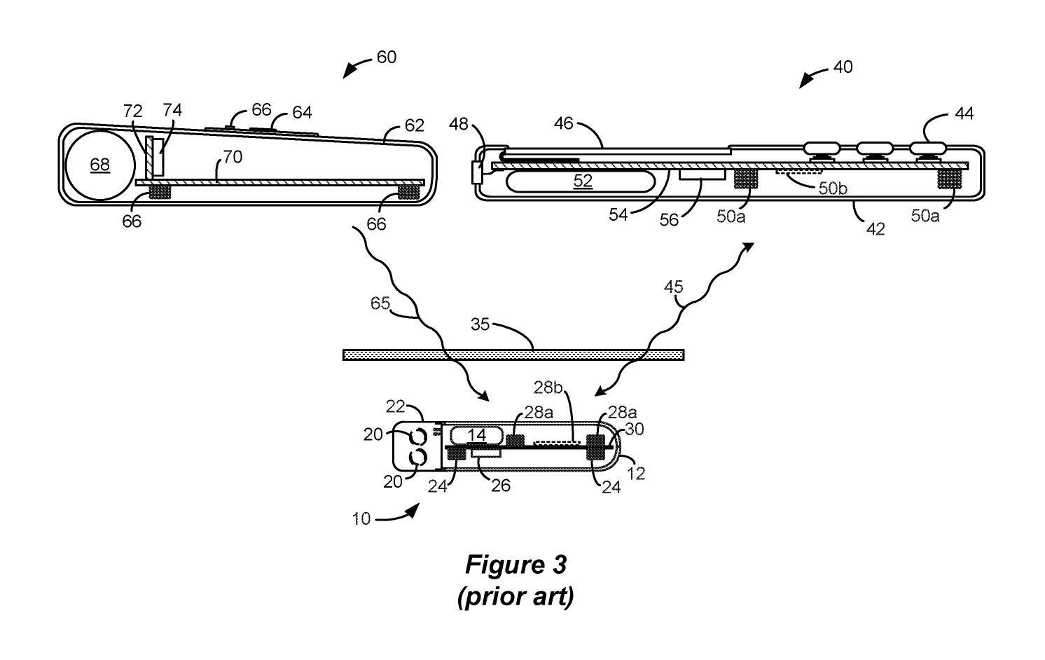

Belt 122 further holds a controller/charger external device 180 coupleable to the charging coil assembly 140 should the patient's IMD 10 require charging. Unlike the charging coil assembly 140 which is preferably permanently or semi-permanently integrated with the belt 122, the controller/charger 180 is preferably easily insertable into and removeable from the belt 122. This allows the controller/charger 180 to be used by itself to send and receive data to and from a patient's IMD via link 45 (FIG. 3) during periods when charging of the patient IMD battery 14, and hence use of the holding device 120, is not needed. In this regard, the controller/charger 180 can be generally similar in structure and function to the external controller devices (e.g., 40 and 100) described earlier, and used for example to change or adjust a stimulation program for the IMD 10.

While the controller/charger 180 can be retained within the inner and outer fabric of the belt similarly to the charging coil assembly 140, it is instead depicted in FIG. 6 as retained in a pouch 126, which may be affixed to the outer surface of the belt 122. The pouch 126 as shown includes a slot 128 for insertion and removal of the controller/charger 180, which again may be openable and closeable such as by use of a Velcro flap. Slot 128 may also comprise a more general opening into which the controller/charger 180 can be easily inserted or removed, but which still firmly retains the device. Pouch 126 preferably also includes an opening 132 through which port 48 on the controller/charger 180 can be accessed for connection of the connector 162 of the charging coil assembly 140.

In one example, both port 48 on the controller/charger 180 and connector 162 of the charging coil assembly comprise Universal Serial Bus (USB) devices. However, this is not strictly necessary, and other communication means could be used. For example, port 48 and connector 162 could comprise coaxial audio connections in other examples. See, e.g., U.S. Patent Application Ser. No. 62/131,975, filed Mar. 12, 2015.

As illustrated in FIG. 6, the pouch 126 may include a translucent window 130 allowing the display 46 of the controller/charger 180 to be seen when inserted in the pouch 126. However, this is not strictly necessary, as controller/charger 180 when coupled to the charging coil assembly 140 can be used to charge a patient's IMD 10 without the need to access or see the GUI of the controller/charger 180, as explained further below.

Pouch 126 may be moveable along the belt 122, thus allowing its position to be adjusted along the length of the belt. For example, and although not shown, the back side of the pouch 126 can include Velcro with opposing Velcro on the outer surface of the belt 122 where the pouch 126 is to be attached. Having a removable or adjustable pouch 126 for the controller/charger 180 allows the controller/charger 180 to be positioned appropriately on the belt 122 for different sized patients and at an appropriate distance relative to the integrated charging coil assembly 140.

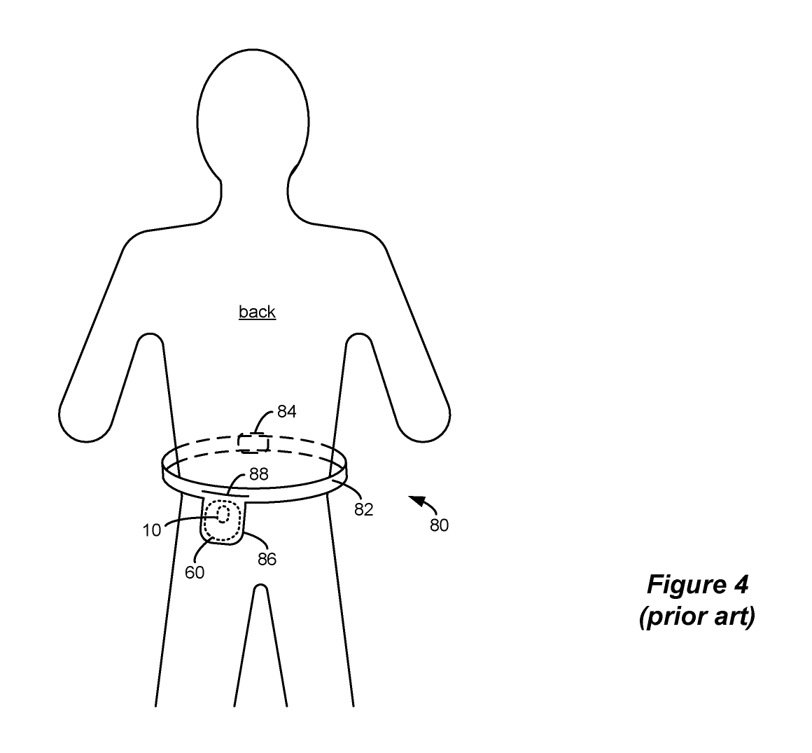

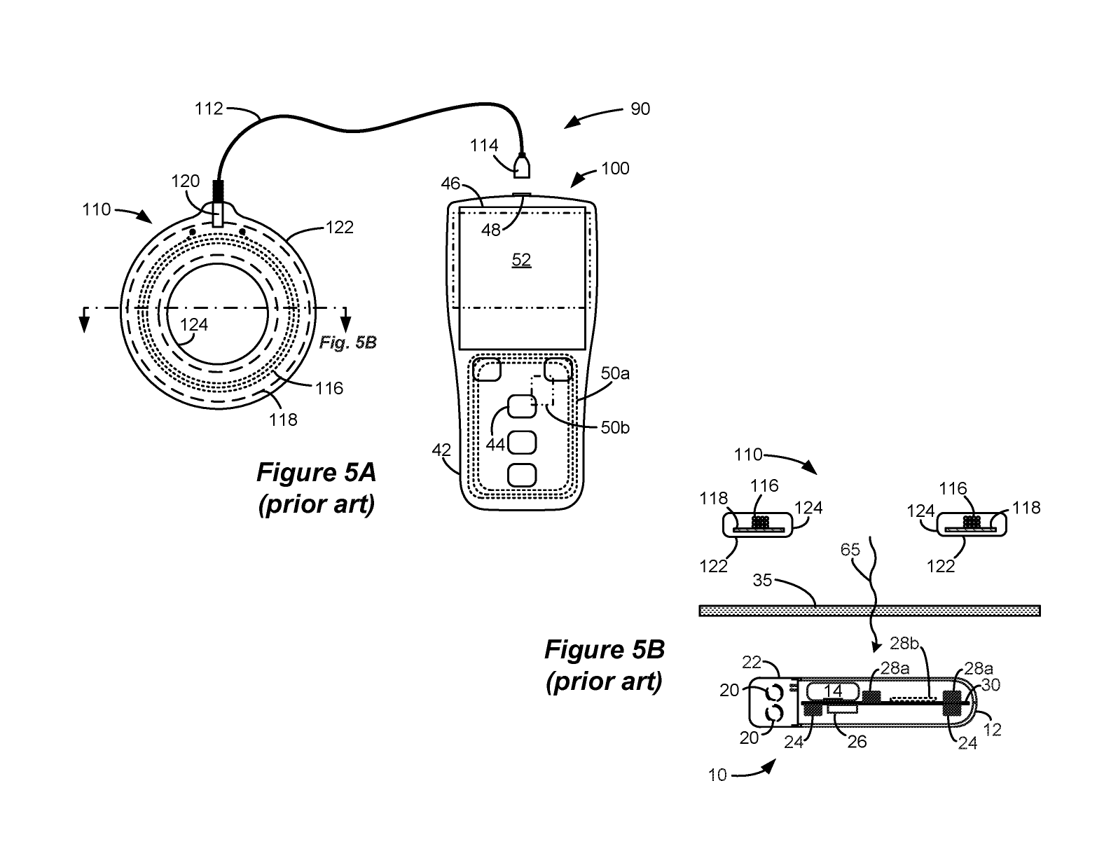

In this regard, it should be understood that the location of the charging coil assembly 140 and the pouch 126 on the belt 122 may vary from patient to patient, and may additionally vary in accordance with the type and location of implantation of the patient's IMD 10. For example, for an Spinal Cord Stimulation (SCS) IMD patient, the charging coil assembly 140 should be positioned along the belt 122 so that it is behind the patient when fastened (124) around the patient's waist, thus bringing the charging coil 148 into good alignment with the patient's IMD 10, similar to the location shown in FIG. 4. The pouch 126 in this circumstance would probably most conveniently be positioned on the front of the belt where it is most easily accessed by the patient. Thus, in this example, the cable 160 connecting the charging coil assembly 140 to the controller/charger 180 might be relatively long. By contrast, for a Deep Brain Stimulation (DBS) IMD patient, in which the IMD 10 is implanted under the patient's collarbone, the holding device 120 would likely drape around the patient's neck, with the charging coil assembly 140 positioned on the front of the belt 122 proximate to the IMD. The pouch 126 for the controller/charger 180 would also preferably be on the front of the belt 122 for patient convenience, and hence cable 160 might be much shorter in this example. Note that regardless of the relative positioning of the charging coil assembly 140 and the pouch 126 on the belt, it is preferred that the cable 160 connecting them not have undue slack.

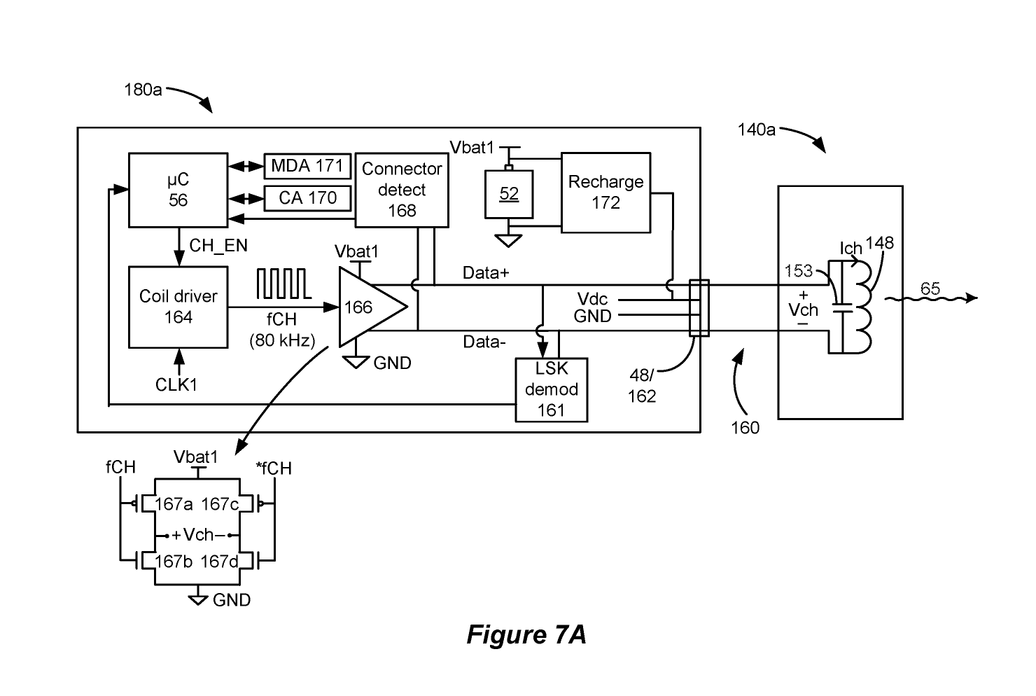

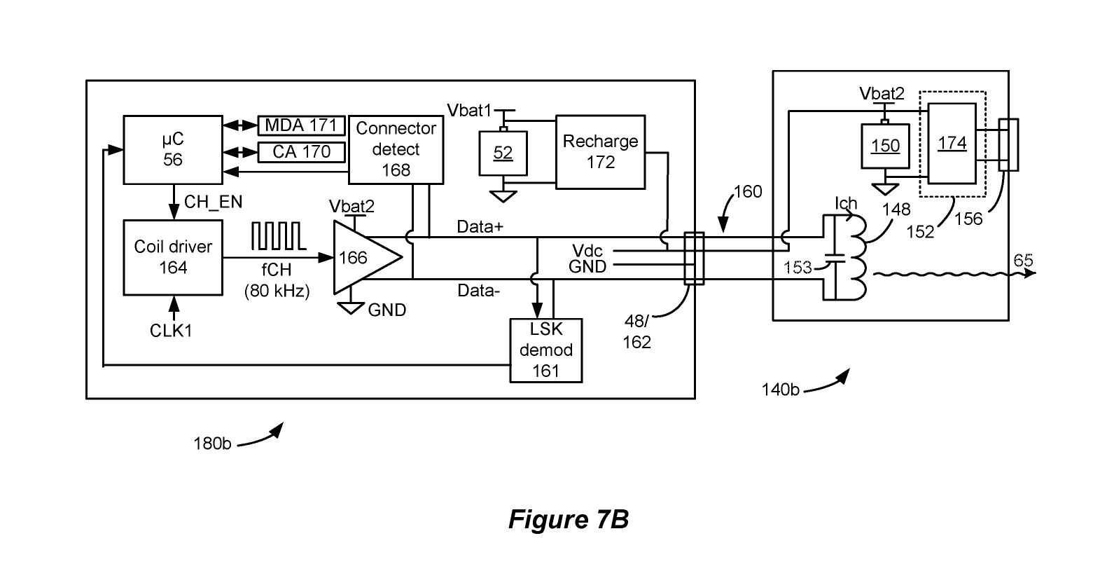

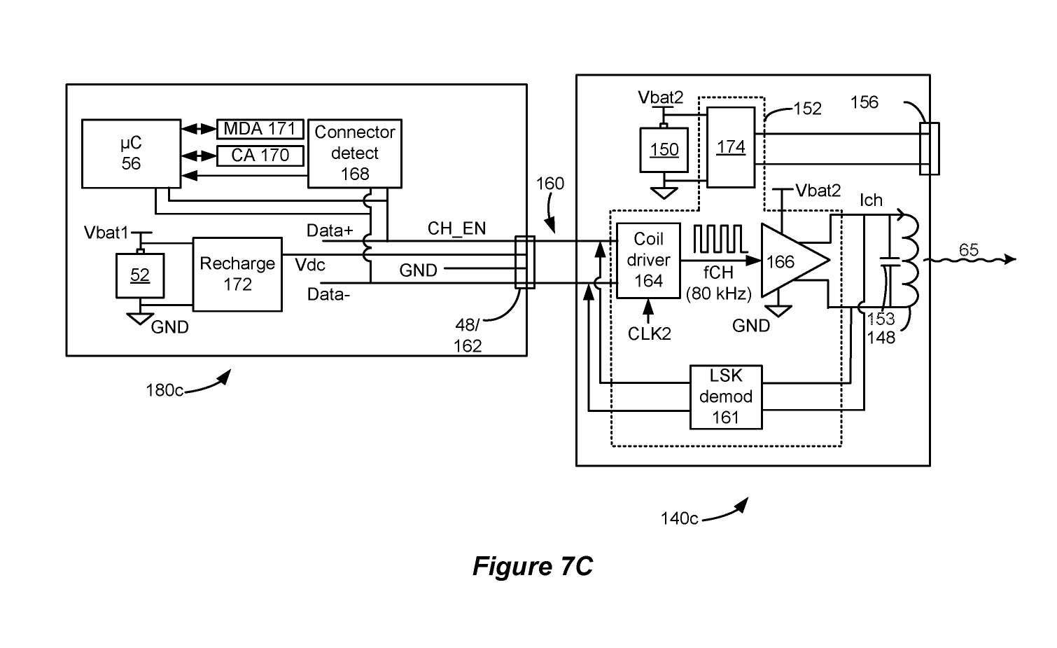

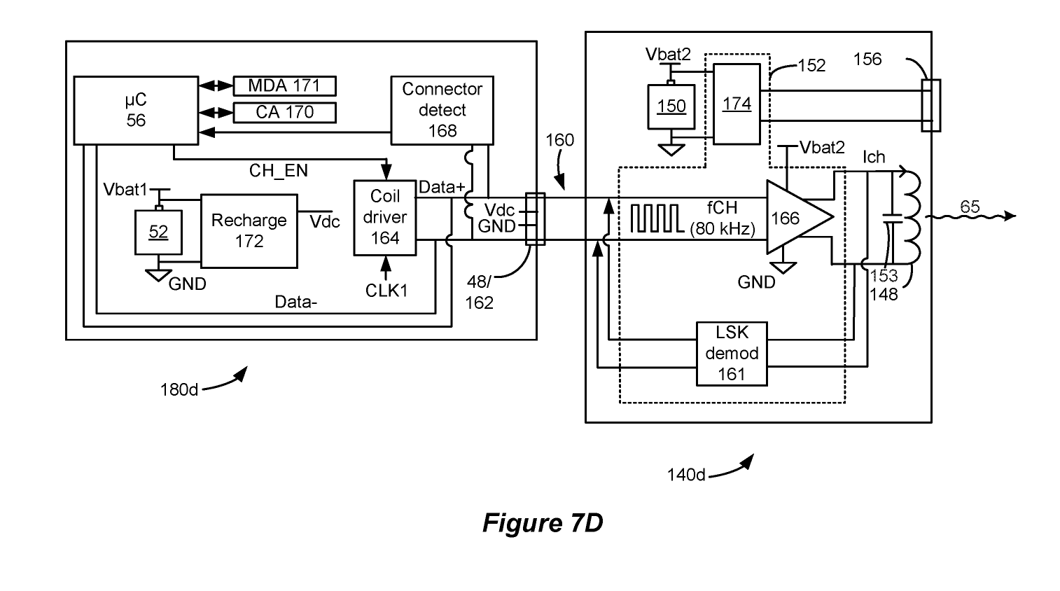

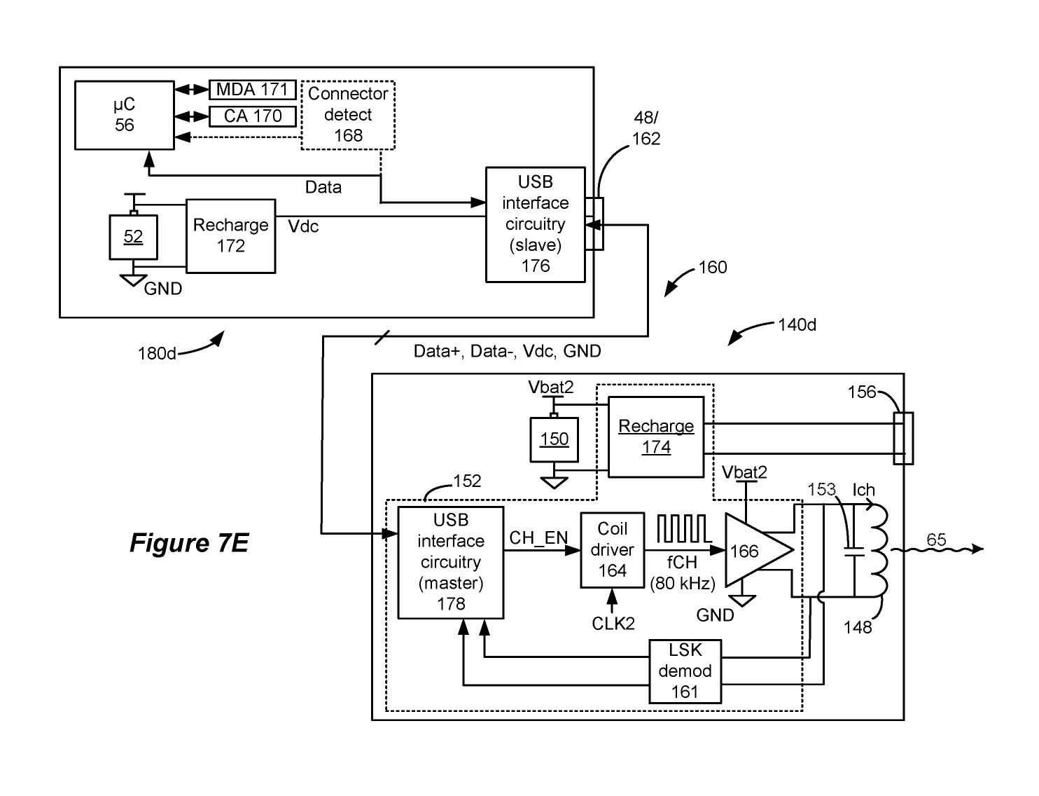

FIGS. 7A through 7E show different examples of circuitry in the controller/charger 180 and the charging coil assembly 140. In these illustrations, and although not strictly necessary, it is assumed that the port 48 on the controller/charger 180 and connector 162 of the charging coil assembly 140 are USB-based. Although the various examples of charging coil assemblies 140 can contain thermistors 154 (FIG. 6), this is not shown in FIGS. 7A through 7E, which instead focus on various ways in which the charging coil 148 in the various accessories 140 can be driven and powered.

In each of the depicted examples, generation of a magnetic charging field 65 occurs under control of the controller/charger 180, and occurs automatically when connector 162 of the charging coil assembly 140 is connected to port 48 of the controller/charger 180. This is beneficial, as a patient requiring charging need only wear the holding device 120, insert controller/charger 180 into pouch 126, and connect the connector 162 to the port 48 to charge the battery 14 of his IMD 10. Reviewing or accessing the Graphical User Interface (GUI) of the controller/charger 180 isn't required, thus conveniencing the patient. Nor does the patient thereafter need to handle the controller/charger 180 during the charging session, and can instead freely move about. The controller/charger 180 can notify the patient when the battery 14 of his IMD has been fully charged, such as by an audible tone, at which point the patient can remove the controller/charger 180, and remove the holding device 120 until such time as charging is again required.

While reviewing or accessing the GUI of the controller/charger 180 may not be necessary as concerns charging functionality, it should be noted that a GUI may still be provided by the MDA 171 to allow a patient to control and/or monitor the IMD 10 via telemetry link 45 (FIG. 3) when the connector 162 of the charging coil assembly is coupled to the controller/charger 180, and hence while the magnetic charging field 65 is being generated. While such telemetry with the IMD 10 may occur directly between the controller/charger 180 and the IMD 10, such telemetry may also be routed through the charging coil 148 in the charging coil assembly during the charging session, as disclosed in U.S. Pat. No. 8,463,392. In other examples, MDA 171 may be precluded from providing an IMD control/monitoring GUI during use of the charging coil assembly, or during generation of the charging field. Of course, MDA 171 can be used to control and/or monitor the IMD 10 when the connected 162 is not connected and when charging is not occurring, as in legacy systems.

Detecting insertion of the connector 162 is enabled in the various examples of FIGS. 7A-7E by connection detect circuitry 168. When USB-based hardware is used to communicate between the controller/charger 180 and the charging coil assembly 140, such circuitry 168 can monitor any of the signals in cable 160 prescribed by USB protocols and supported by port 48 and connector 162, including differential data signals Data+ and Data−, the Vdc power supply signal, or even the ground signal GND. In one example, connection detect circuitry 168 can comprise Part Number AAT3685, provided by Skyworks Solutions, Inc. Although not shown, connection detect circuitry 168 can also operate by virtue of detecting resistive terminations provided on one or more of the signals in the housing 144 of the charging coil assembly 140. It should be noted that data and other signaling between the controller/charger 180 and the charging coil assembly 140 can be single ended, and need not be differential.

Connection detect circuitry 168 reports to the microcontroller 56 of the controller/charger 180. In turn, a Charging Application 170 stored in the controller/charger 180, and discussed further below, can enable a coil driver circuit 164 (via signal CH_EN) to produce an amplifier driving signal (fCH). As shown in FIGS. 7A-7E, the amplifier driving signal may comprise a square wave whose frequency is preferably tuned to the resonance of the L-C circuitry established by the inductance of the charging coil 148 and its tuning capacitor 153 (e.g., 80 kHz).

The amplifier driving signal fCH is input to an amplifier 166, and one example of the amplifier 166 is provided in detail in FIG. 7A. As shown, the amplifier 166 comprises two P—(167a, 167c) and two N—(167b, 176d) channel transistors, which are presented with amplifier driving signal fCH or its complement *fCH to impress in alternating sequence a positive and negative battery voltage (in FIG. 7A, the voltage Vbat1 of battery 52 in the controller/charger 180a) across the charging coil 148 (Vch). This in turn causes the charging coil 148 to produce the AC magnetic charging field 65 to charge the battery 14 in the IMD 10. The depicted amplifier 166 is just one example, and other amplifier circuits may be used instead, including those that only place a single polarity of the battery voltage across the coil 116, and those that are controlled with only a single (non-complementary) input. For example, a well-known Class E amplifier could be used as well.

The Charging Algorithm CA 170 may be used to automatically begin generation of the magnetic charging field at the charging coil 148 upon receiving confirmation of receipt of connector 162 from connection detect circuitry 168. The Charging Application 170 may also operate in conjunction with, or may comprise a portion of, a Medical Device Application (MDA) 171 which can configure the controller/charger 180 to control and monitor the IMD 10, as described in the above-incorporated '498 Publication. However, while MDA 171 will configure a GUI of the controller/charger 180 to allow for patient interaction, the Charging Application 170 by contrast preferably does not implicate the GUI at all, thus simplifying charging of the IMD battery 14.

As well as automatically initiating generation of the magnetic charging field 65, the Charging Application 170 may further control the magnetic charging field 65 during a charging session. For example, although not shown in FIGS. 7A-7E, temperature data from optional thermistors 154 (FIG. 6) in the charging coil assembly 140 can be reported via cable 160 to the Charging Application 170 in the controller/charger 180. The Charging Application 170 can in turn instruct the microcontroller 56 to control the coil driver 164 (e.g., on and off) and/or the amplifier 166 (e.g., the charging coil current, Ich) to control the duty cycle and/or intensity of the magnetic charging field 65 such that a safe temperature set point temperature is not exceeded (e.g., 41 C).

Charging Application 170 control may also be assisted by telemetry received from the IMD 10, allowing for closed loop control of the magnetic charging field 65. In this regard, the IMD 10 may telemeter data by Load Shift Keying (LSK). As is well known, LSK involves modulating with data the impedance of the charging coil 24 (FIG. 3) in the IMD 10. Due to mutual inductance between the charging coils 26 and 148, such impedance variation will be reflected in the voltage across transmitting charging coil 148 (Vch) in the charging coil assembly 140. This voltage can be monitored by an LSK demodulator 161, with recovered digital data provided to the microcontroller 56 and the Charging Application 170 so that magnetic charging field 65 generation may be controlled, again in its intensity or duty cycle, or perhaps even its frequency.

The examples of the controller/charger 180 in FIGS. 7A-7E can include battery recharge circuitry 172 for recharging the battery 52. When USB-based hardware is used, the battery recharge circuitry 172 receives input from the Vdc power supply signal of port 48, and hence the battery 52 can be recharged at this port when the charging coil assembly 140 is not connected. Part Number AAT3685 can again be used as the battery recharge circuitry 172, and so this part can perform both of the connection detect and battery recharging functions (168 and 172) of the controller/charger 180.

FIG. 7A shows an example in which charging coil assembly 140a does not contain any of the circuitry necessary to drive or power the charging coil 148, and thus as depicted only includes the charging coil 148 and its tuning capacitor 153 (again, ignoring thermistors). Instead, such driving and powering components, including the coil driver 164 and the amplifier 166, are included in controller/charger 180a. In this example, note that the amplifier 166 is powered by the battery 52 within the controller/charger 180a. This renders the charging coil assembly 140a simpler in construction, but will deplete the controller/charger 180a's battery 52 more quickly than when the controller/charger 180a is used only for data communications with the IMD data, although the ability to recharge the battery (172) can mitigate this concern.

Coil driver 164 receives a clock signal (CLK1), which may comprise or be generated from the master internal clock governing the controller/charger 180a's circuitry (including for example the microcontroller 56). Receiving clock signal CLK1 allows the coil driver 164 to issue the amplifier driving signal fCH with the proper timing and frequency.

In FIG. 7A, the data signal Data+ and Data− are used to carry the output of the amplifier 166 (Vch) to the charging coil 148 in the charging coil assembly 140a, causing current Ich to flow through the coil 148, and the magnetic charging field 65 to be generated. LSK demodulator 161 in this example is provided in the controller/charger 180a to assist in controlling magnetic charging field 65 generation as described earlier.

FIG. 7B shows an example in which charging coil assembly 140b again does not contain any of the circuitry necessary to drive or power the charging coil 148; thus, coil driver 164 and amplifier 166 are again within the controller/charger 180b, and the signal to drive the charging coil 148 is sent via data lines Data+ and Data−. However, in this example, the charging coil assembly 140a includes its own battery 150. The battery voltage produced by this battery, Vbat2, is sent to the controller/charger 180b via cable signal line Vdc. Thus, the battery 150 can provide the power for driving the coil, and note that amplifier 166 is powered by Vbat2 produced by battery 150. This can be useful if the battery 52 in the controller/charger 180b lacks sufficient capacity to provide the additional (and significantly higher) power need to produce the magnetic charging field 65.

Additionally shown in FIG. 7B is recharging circuitry 174 within the charging coil assembly 140b which can be used to recharge its battery 150. As with the controller/charger 180b, external power for recharging battery 150 in the charging coil assembly 140b can be provided at its optional port 156, which as noted earlier can be accessible through an opening 155 (FIG. 6) in the belt 122.

In FIG. 7C, the charging coil assembly 140c includes the circuitry necessary to drive and power the charging coil 148, including coil driver 164 and amplifier 166. Thus, upon detection of a connection (168), the microcontroller 56 in the controller/charger 180c can send the charge enable (CH_EN) or other instructional signal to the coil driver 164 in the charging coil assembly 140c via port 48 and data signal Data+ and Data− in cable 160 (although as noted earlier, non-differential signaling could also be used). In this instance, the coil driver 164, may not receive the controller/charger 180c's clock signal (CLK1), and instead a clock signal (CLK2) may be generated within the charging coil assembly 140c itself to issue the amplifier driving signal fCH with the proper timing and frequency. Although not shown, CLK2 may be generated using any number of well-known clocking circuits within the charging coil assembly 140c, including crystal or ring oscillators, phase locked loops, etc.

Charging coil assembly 140c, like 140b (FIG. 7B), also includes its own battery 150 (Vbat2), which provides the power for driving the charging coil 148, and in particular amplifier 166 within the charging coil assembly 140c. Again, battery recharging circuitry 174 may be provided and accessible via optional port 156 of the assembly. Further, in FIG. 7C, the LSK demodulator 161 is also provided in the charging coil assembly 140c, as it needs access to Vch produced by the amplifier 166. Demodulated received data may be reported back to the controller/charger 180c via data lines Data+ and Data−.

FIG. 7D is similar to FIG. 7C, except that the coil driver 164 has been moved from the charging coil assembly 140d to the controller/charger 180d. Thus, data signals Data+ and Data− carry the amplifier driving signal fCH to amplifier 166 as a differential signal (although again non-differential signaling could be used). The amplifier 166 remains powered by the charging coil assembly 140d's battery 150.

FIG. 7E illustrates examples of the controller/charger 180e and charging coil assembly 140e in which interface circuitries 176 and 178 are used to govern communications at the port 48/connector 162 and along the cable 160 in accordance with a particular communication standard. As with earlier examples, this standard is assumed to be USB-based, and hence the interface circuitries are compliant with that standard.

In one example, the USB interface circuitry 176 in the controller/charger 180e comprises slave to the master USB interface circuitry 178 operating in the charging coil assembly 140e. As such, master USB interface circuitry 178 will handshake with the controller/charger 180e when connected via connector 162 to allow communications to be established over cable 160. This being said, interface circuitry 176 may also comprise a master to interface circuitry 178 as the slave.

Once communications are established, slave USB interface circuitry 176 in the controller/charger 180e can instruct its microcontroller 56 of this fact (via signal Data). In this regard, discrete connector detection circuitry 168 isn't necessarily needed in the controller/charger 180e (and hence is shown in dotted lines in FIG. 7E), as slave USB interface circuitry 176 can perform connection detection functionality. Once the microcontroller 56 understands charging coil assembly 140e to be connected to the controller/charger 180e, it may send an instruction (via Data) to its slave USB interface circuitry 176, and in turn to the master USB interface circuitry 178 in the charging coil assembly 140e (via Data+ and Data−). The master USB circuitry 178 can in turn generate a charge enable signal (CH_EN) to the coil driver 164 as necessary to generate the magnetic charging field 65, as explained earlier.

Otherwise, the examples of the controller/charger 180e and charging coil assembly 140e of FIG. 7E are similar to those (180c, 140c) of FIG. 7C: the coil driver 164 and amplifier 166 are again included in the charging coil assembly 140e, and the assembly includes its own battery 150 for powering of at least the amplifier 166 and for generation of the magnetic charging field 65.

As illustrated to this point, the holding device 120 includes a permanent or semi-permanent charging coil assembly 140. However, and at least in situations where the charging coil assembly 140 is semi-permanent and removable from the belt 122, such as through slot 141 (FIG. 6), different charging coil assemblies 140 could be used, as disclosed in U.S. Pat. No. 8,682,444, which is incorporated herein by reference. As explained in the '444 patent, this allows the controller/charger 180 to charge different types of IMDs 10, or different numbers of IMDs 10, with charging coils 148 of an appropriate sizes and powers. That is, the strength of the magnetic charging fields 65 issued from various charging coil assemblies 140 useable with the holding device 120 can be controlled to vary in intensity, shape, or frequency. This can occur for example by the Charging Application 170 detecting an address of a particular one of the charging coil assemblies 140 via cable 160.

While the controller/charger 180 has to this point been illustrated as being similar in construction to the dedicated external controller 40 (FIG. 2A) described earlier and as typically provided by the IMD manufacturer, the controller/charger may also comprise a general purpose mobile device, such as a smart cell phone, or even an optical head-mounted display such as Google Glass. In such example, the Charging Application 170 can be downloaded to the device through normal wireless means, such as from an Internet server, and perhaps via an “app store.” The examples of FIG. 7C and 7E are best used when the controller/charger 180 comprises a general purpose mobile device, as these examples use circuitry normally present in such devices, and move circuitry not likely to be present in a mobile device (such as the coil driver 164 and amplifier 166, and LSK demodulation circuitry 161) to the charging coil assembly 140.

While the holding device 120 and its charging coil assembly 140 have been described as useful for charging an IMD battery 14, note that this system can also be used to provide a magnetic charging field to IMDs which do not have batteries, but which require continuous external wireless power to operate.

While the controller/charger 180 and Charging Application 170 have been described to this point as automatically generating the magnetic charging field 65 when the connector 162 is coupled to the port 48 and without receiving input from the GUI, generation of the magnetic charging field 65 could also implicate the GUI in other examples. For example, the display 46 may indicate “Charging coil detected. Do you want to initiate charging? YES/NO,” and receive an input (via buttons 44 for example) before the magnetic charging field 65 is generated. Even if the magnetic charging field 65 is automatically generated and patient input is not required, the display 46 might indicate this fact (e.g., “Charging underway”), and may additional indicate various pieces of charging information, such as IPG battery 14 voltage, estimated time left to recharge or that charging is complete, temperature (as reported via thermistors 154), information concerning charging coil assembly 140 to IPG 14 alignment, etc.

Microcontroller control circuitry operable in the controller/charger 180 can comprise for example Part Number MSP430, manufactured by Texas Instruments, which is described in data sheets at http://www.ti.com/1sds/ti/microcontroller/16-bit msp430/overview.page? DCMP=MCU_other& HQS=msp430, which is incorporated herein by reference. However, other types of control circuitry may be used in lieu of a microcontroller as well, such as microprocessors, FPGAs, DSPs, or combinations of these, etc.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A charging system for an implantable medical device (IMD), comprising:
a holding device wearable by a patient having an IMD, the holding device configured to hold an external device;
a charging coil assembly integrated within the holding device, comprising:
a charging coil configured to generate a magnetic charging field for the IMD, and
a connector; and
the external device comprising a port, wherein the external device is configured to:
provide a user interface to allow a patient to control and/or monitor the IMD, and
automatically generate the magnetic charging field when the connector is coupled to the port.

2. The system of claim 1, wherein the charging coil assembly further comprises a cable between the charging coil and the connector.

3. The system of claim 1, wherein the holding device comprises a belt or collar.

4. The system of claim 1, wherein the holding device is configured to hold the external device at a pouch.

5. The system of claim 4, wherein the pouch is affixed to the holding device.

6. The system of claim 4, wherein a position of the pouch is adjustable along a length of the holding device.

7. The system of claim 1, wherein the charging coil assembly comprises a housing.

8. The system of claim 7, wherein the housing comprises a second battery for powering the generation of the magnetic charging field.

9. The system of claim 7, wherein the housing further comprises the charging coil.

10. The system of claim 8, wherein the external device comprises a first battery.

11. The system of claim 1, wherein the external device is configured to provide the user interface to allow a patient to control and/or monitor the IMD when the connector is not coupled to the port.

12. The system of claim 1, wherein the external device is additionally configured to provide the user interface to allow a patient to control and/or monitor the IMD when the connector is coupled to the port.

13. The system of claim 1, wherein the connector and port are Universal Serial Port based.

14. The system of claim 1, wherein the external device further comprises an antenna to allow the patient to control and/or monitor the IMD.

15. The system of claim 14, wherein the antenna comprises at least one coil.

16. The system of claim 14, wherein the antenna comprises at least one short-range RF antenna.

17. The system of claim 1, wherein the external device further comprises detection circuitry configured to detect when the connector is coupled to the port, and wherein the detection circuitry instructs control circuitry in the external device to automatically generate the magnetic charging field when the connector is coupled to the port.

18. The system of claim 1, wherein the system further comprises an amplifier to drive the charging coil to generate the magnetic charging field.

19. The system of claim 18, wherein the external device further comprises a first battery, and wherein the first battery is configured to provide power to the amplifier.

20. The system of claim 19, wherein the amplifier is located within the integrated external controller/charger.

21. The system of claim 18, wherein the charging coil assembly further comprises a second battery, and wherein the second battery is configured to provide power to the amplifier.

22. The system of claim 21, wherein the amplifier is located within the integrated external controller/charger.

23. The system of claim 21, wherein the amplifier is located within the charging coil assembly.

24. The system of claim 18, wherein the external device further comprises a first battery, and wherein the charging coil assembly further comprises a second battery, and wherein the second battery is configured to provide power to the amplifier.

25. The system of claim 1, wherein the external device further comprises demodulation circuitry configured to receive data telemetry from the IMD when the magnetic charging field is being produced.

26. The system of claim 1, wherein the charging coil assembly further comprises demodulation circuitry configured to receive data telemetry from the IMD when the magnetic charging field is being produced.

27. The system of claim 1, wherein the external device is further configured to automatically determine the charging coil assembly coupled to the port from a plurality of different charging coil assemblies coupleable to the port and integratable within the holding device, and to automatically control the magnetic charging field in accordance with the determined charging coil assembly.

28. The system of claim 1, wherein the user interface of the external device comprises a graphical user interface.

29. The system of claim 1, wherein the external device is configured to automatically generate the magnetic charging field when the connector is coupled to the port and without receiving input from the user interface.
